(19) United States
(12) Patent Application Publication
(10) Pub. No.: US 2015/0081797 A1
(43) Pub. Date: Mar. 19, 2015

(54) System and Method for Continuous Social Communication

(71) Applicant: MARKETWIRE L.P., Toronto (CA)

(72) Inventor: Stuart OGAWA, Los Gatos, CA (US)

(73) Assignee: MARKETWIRE L.P., Toronto (CA)

(21) Appl. No.: 14/486,265

(22) Filed: Sep. 15, 2014

Related U.S. Application Data
(60) Provisional application No. 61/880,027, filed on Sep. 19, 2013.

(51) Int. Cl. H04L 29/08; G06Q 50/00

(52) U.S. Cl. CPC H04L 29/08072; G06Q 50/01
USPC 709/205

(57) ABSTRACT

A system and method are provided for analysing and communicating social data. A method performed by a computing device or server system includes obtaining social data and deriving at least two concepts from the social data. A relationship between the at least two concepts is determined. The method also includes composing a new social data object using the relationship and transmitting the new social data object. User feedback associated with new social data object is obtained, and the computing device or server system computes an adjustment command using the user feedback. Executing the adjustment command adjusts a parameter used in the method. After the adjustment command is executed, the method is repeated.

### CROSS-REFERENCE TO RELATED APPLICATIONS

This application claims priority to U.S. Provisional Patent Application No. 61/880,027 filed on Sep. 19, 2013, and titled “System and Method for Continuous Social Communication” and the entire contents of which is incorporated herein by reference.

### TECHNICAL FIELD

The following generally relates to communication of social data.

### BACKGROUND

In recent years social media has become a popular way for individuals and consumers to interact online (e.g. on the Internet). Social media also affects the way businesses aim to interact with their customers, fans, and potential customers online.

Typically a person or persons create social media by writing messages (e.g. articles, online posts, blogs, comments, etc.), creating a video, or creating an audio track. This process can be difficult and time consuming.

### BRIEF DESCRIPTION OF THE DRAWINGS

Embodiments will now be described by way of example only with reference to the appended drawings wherein:

FIG. 1 is a block diagram of a social communication system interacting with the Internet or a cloud computing environment, or both.

FIG. 2 is a block diagram of an example embodiment of a computing system for social communication, including example components of the computing system.

FIG. 3 is a block diagram of an example embodiment of multiple computing devices interacting with each other over a network to form the social communication system.

FIG. 4 is a schematic diagram showing the interaction and flow of data between an active receiver module, an active composer module, an active transmitter module and a social analytic synthesizer module.

FIG. 5 is a flow diagram of an example embodiment of computer executable or processor implemented instructions for composing new social data and transmitting the same.

FIG. 6 is a block diagram of an active receiver module showing example components thereof.

FIG. 7 is a flow diagram of an example embodiment of computer executable or processor implemented instructions for receiving social data.

FIG. 8 is a block diagram of an active composer module showing example components thereof.

FIG. 9A is a flow diagram of an example embodiment of computer executable or processor implemented instructions for composing new social data.

FIG. 9B is a flow diagram of an example embodiment of computer executable or processor implemented instructions for combining social data according to an operation described in FIG. 9A.

FIG. 9C is a flow diagram of an example embodiment of computer executable or processor implemented instructions for extracting social data according to an operation described in FIG. 9A.

FIG. 9D is a flow diagram of an example embodiment of computer executable or processor implemented instructions for creating social data according to an operation described in FIG. 9A.

FIG. 10 is a block diagram of an active transmitter module showing example components thereof.

FIG. 11 is a flow diagram of an example embodiment of computer executable or processor implemented instructions for transmitting the new social data.

FIG. 12 is a block diagram of a social analytic synthesizer module showing example components thereof.

FIG. 13 is a flow diagram of an example embodiment of computer executable or processor implemented instructions for determining adjustments to be made for any of the processes implemented by the active receiver module, the active composer module, and the active transmitter module.

### DETAILED DESCRIPTION OF THE DRAWINGS

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Social data herein refers to content able to be viewed or heard, or both, by people over a data communication network, such as the Internet. Social data includes, for example, text, video, graphics, and audio data, or combinations thereof. Examples of text include blogs, emails, messages, posts, articles, comments, etc. For example, text can appear on websites such as Facebook, Twitter, LinkedIn, Pinterest, other social networking websites, magazine websites, newspaper websites, company websites, blogs, etc. Text may also be in the form of comments on websites, text provided in an RSS feed, etc. Examples of video can appear on Facebook, YouTube, news websites, personal websites, blogs (also called vlogs), company websites, etc. Graphical data, such as pictures, can also be provided through the above mentioned outlets. Audio data can be provided through various websites, such as those mentioned above, audio-casts, “Pod casts”, online radio stations, etc. It is appreciated that social data can vary in form.

A social data object herein refers to a unit of social data, such as a text article, a video, a comment, a message, an audio track, a graphic, or a mixed-media social piece that includes different types of data. A stream of social data includes multiple social data objects. For example, in a string of comments from people, each comment is a social data object. In another example, in a group of text articles, each article is a social data object. In another example, in a group of videos, each video file is a social data object. Social data includes at least one social data object.

It is recognized that effective social communication, from a business perspective, is a significant challenge. The expansive reach of digital social sites, such as Twitter, Facebook, YouTube, etc., the real time nature of communication, the different languages used, and the different communication modes (e.g. text, audio, video, etc.) make it challenging for businesses to effectively listen to and communicate with their customers. The increasing number of websites, channels, and communication modes can overwhelm businesses with too much real time data and little appropriate and relevant information. It is also recognized that people in decision making roles in business are often left wondering who is saying what, what communication channels are being used, and which people are important to listen to.

It is recognized that typically a person or persons generate social data. For example, a person generates social data by writing a message, an article, a comment, etc., or by generating other social data (e.g. pictures, video, and audio data). This generation process, although sometimes partially aided by a computer, is time consuming and uses effort by the person or persons. For example, a person typically types in a text message, and inputs a number of computing commands to attach a graphic or a video, or both. After a person creates the social data, the person will need to distribute the social data to a website, a social network, or another communication channel. This is also a time consuming process that requires input from a person.

It is also recognized that when a person generates social data, before the social data is distributed, the person does not have a way to estimate how well the social data will be received by other people. After the social data has been distributed, a person may also not have a way to evaluate how well the content has been received by other people. Furthermore, many software and computing technologies require a person to view a website or view a report to interpret feedback from other people.

It is also recognized that generating social data that is interesting to people, and identifying which people would find the social data interesting is a difficult process for a person, and much more so for a computing device. Computing technologies typically require input from a person to identify topics of interest, as well as identify people who may be interested in a topic. It also recognized that generating large amounts of social data covering many different topics is a difficult and time-consuming process. Furthermore, it is difficult achieve such a task on a large data scale within a short time frame.

The proposed systems and methods described herein address one or more of these above issues. The proposed systems and methods use one or more computing devices to receive social data, identify relationships between the social data, compose new social data based on the identified relationships and the received social data, and transmit the new social data. In a preferred example embodiment, these systems and methods are automated and require no input from a person for continuous operation. In another example embodiment, some input from a person is used to customize operation of these systems and methods.

The proposed systems and methods are able to obtain feedback during this process to improve computations related to any of the operations described above. For example, feedback is obtained about the newly composed social data, and this feedback can be used to adjust parameters related to where and when the newly composed social data is transmitted. This feedback is also used to adjust parameters used in composing new social data and to adjust parameters used in identifying relationships. Further details and example embodiments regarding the proposed systems and methods are described below.

The proposed systems and methods may be used for real time listening, analysis, content composition, and targeted broadcasting. The systems, for example, capture global data streams of data in real time. The stream data is analyzed and used to intelligently determine content composition and intelligently determine who, what, when, and how the composed messages are to be sent.

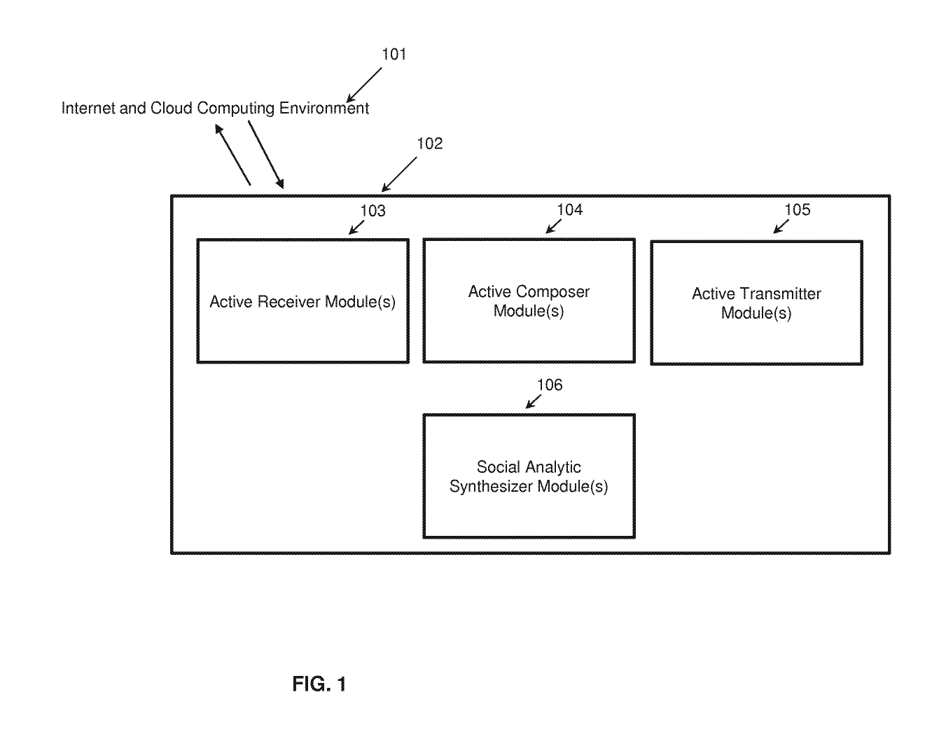

Turning to FIG. 1, the proposed system 102 includes an active receiver module 103, an active composer module 104, an active transmitter module 105, and a social analytic synthesizer module 106. The system 102 is in communication with the Internet or a cloud computing environment, or both 101. The cloud computing environment may be public or may be private. In an example embodiment, these modules function together to receive social data, identify relationships between the social data, compose new social data based on the identified relationships and the received social data, and transmit the new social data.

The active receiver module 103 receives social data from the Internet or the cloud computing environment, or both. The receiver module 103 is able to simultaneously receive social data from many data streams. The receiver module 103 also analyses the received social data to identify relationships amongst the social data. Units of ideas, people, location, groups, companies, words, number, or values are herein referred to as concepts. The active receiver module 103 identifies at least two concepts and identifies a relationship between the at least two concepts. For example, the active receiver module identifies relationships amongst originators of the social data, the consumers of the social data, and the content of the social data. The receiver module 103 outputs the identified relationships.

The active composer module 104 uses the relationships and social data to compose new social data. For example, the composer module 104 modifies, extracts, combines, or synthesizes social data, or combinations of these techniques, to compose new social data. The active composer module 104 outputs the newly composed social data. Composed social data refers to social data composed by the system 102.

The active transmitter module 105 determines appropriate communication channels and social networks over which to send the newly composed social data. The active transmitter module 105 is also configured receive feedback about the newly composed social data using trackers associated with the newly composed social data.

The social analytic synthesizer module 106 obtains data, including but not limited to social data, from each of the other modules 103, 104, 105 and analyses the data. The social analytic synthesizer module 106 uses the analytic results to generate adjustments for one or more various operations related to any of the modules 103, 104, 105 and 106.

In an example embodiment, there are multiple instances of each module. For example, multiple active receiver modules 103 are located in different geographic locations. One active receiver module is located in North America, another active receiver module is located in South America, another active receiver module is located in Europe, and another active receiver module is located in Asia. Similarly, there may be multiple active composer modules, multiple active transmitter modules and multiple social analytic synthesizer modules. These modules will be able to communicate with each other and send information between each other. The multiple modules allows for distributed and parallel processing of data. Furthermore, the multiple modules positioned in each geographic region may be able to obtain social data that is specific to the geographic region and transmit social data to computing devices (e.g. computers, laptops, mobile devices, tablets, smart phones, wearable computers, etc.) belonging to users in the specific geographic region. In an example embodiment, social data in South America is obtained within that region and is used to compose social data that is transmitted to computing devices within South America. In another example embodiment, social data is obtained in Europe and is obtained in South America, and the social data from the two regions are combined and used to compose social data that is transmitted to computing devices in North America.

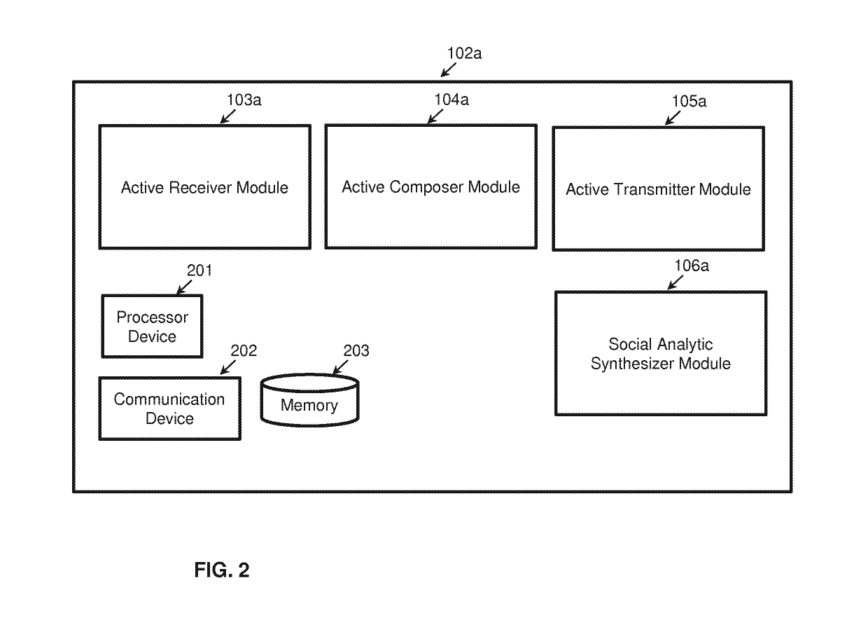

Turning to FIG. 2, an example embodiment of a system 102a is shown. For ease of understanding, the suffix “a” or “b”, etc. is used to denote a different embodiment of a previously described element. The system 102a is a computing device or a server system and it includes a processor device 201, a communication device 202 and memory 203. The communication device is configured to communicate over wired or wireless networks, or both. The active receiver module 103a, the active composer module 104a, the active transmitter module 105a, and the social analytic synthesizer module 106a are implemented by software and reside within the same computing device or server system 102a. In other words, the modules may share computing resources, such as for processing, communication and memory.

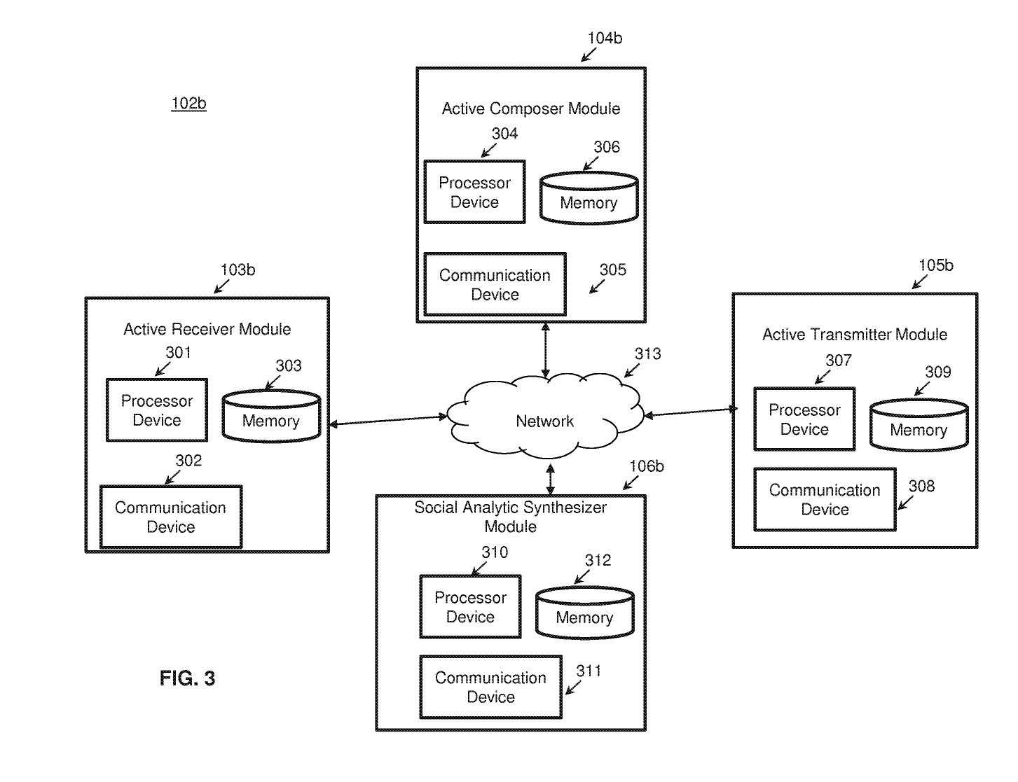

Turning to FIG. 3, another example embodiment of a system 102b is shown. The system 102b includes different modules 103b, 104b, 105b, 106b that are separate computing devices or server systems configured to communicate with each other over a network 313. In particular, the active receiver module 103b includes a processor device 301, a communication device 302, and memory 303. The active composer module 104b includes a processor device 304, a communication device 305, and memory 306. The active transmitter module 105b includes a processor device 307, a communication device 308, and memory 309. The social analytic synthesizer module 106b includes a processor device 310, a communication device 311, and memory 312.

Although only a single active receiver module 103b, a single active composer module 104b, a single active transmitter module 105b and a single social analytic synthesizer module 106b are shown in FIG. 3, it can be appreciated that there may be multiple instances of each module that are able to communicate with each other using the network 313. As described above with respect to FIG. 1, there may be multiple instances of each module and these modules may be located in different geographic locations.

It can be appreciated that there may be other example embodiments for implementing the computing structure of the system 102.

It is appreciated that currently known and future known technologies for the processor device, the communication device and the memory can be used with the principles described herein. Currently known technologies for processors include multi-core processors. Currently known technologies for communication devices include both wired and wireless communication devices. Currently known technologies for memory include disk drives and solid state drives. Examples of the computing device or server systems include dedicated rack mounted servers, desktop computers, laptop computers, set top boxes, and integrated devices combining various features. A computing device or a server uses, for example, an operating system such as Windows Server, Mac OS, Unix, Linux, FreeBSD, Ubuntu, etc.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 102, or any or each of the modules 103, 104, 105, 106, or accessible or connectable thereto. Any application or module herein described may be implemented using computer readable/executable instructions that may be stored or otherwise held by such computer readable media.

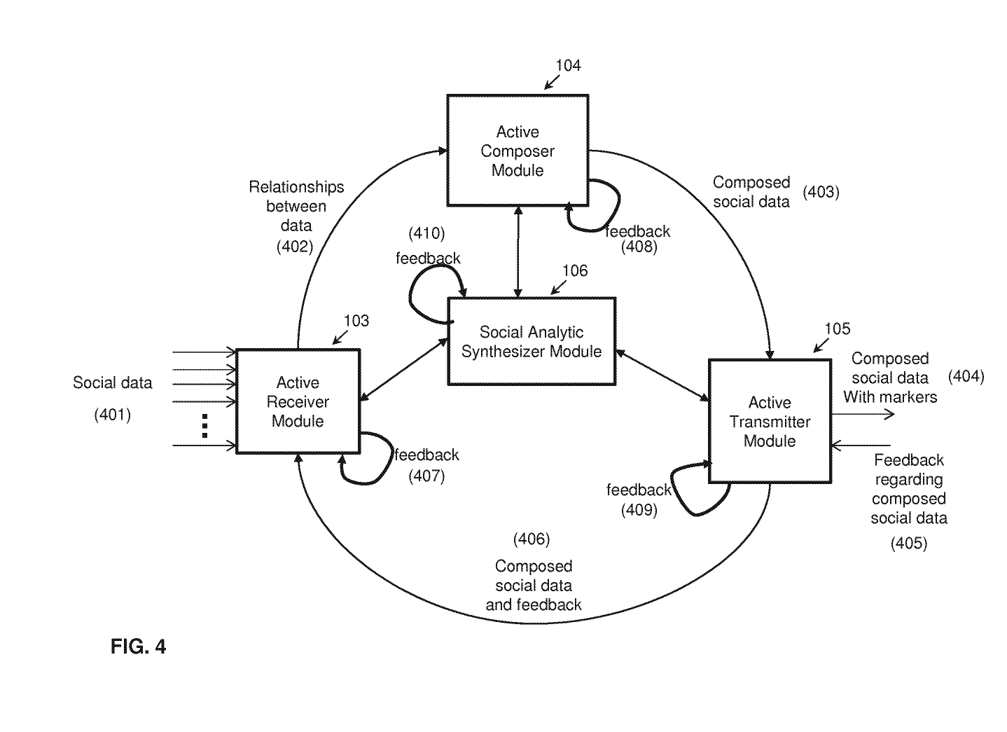

Turning to FIG. 4, the interactions between the modules are shown. The system 102 is configured to listen to data streams, compose automated and intelligent messages, launch automated content, and listen to what people are saying about the launched content.

In particular, the active receiver module 103 receives social data 401 from one or more data streams. The data streams can be received simultaneously and in real-time. The data streams may originate from various sources, such as Twitter, Facebook, YouTube, LinkedIn, Pintrest, blog websites, news websites, company websites, forums, RSS feeds, emails, social networking sites, etc. The active receiver module 103 analyzes the social data, determines or identifies relationships between the social data, and outputs these relationships 402.

In a particular example, the active receiver module 103 obtains social data about a particular car brand and social data about a particular sports team from different social media sources. The active receiver 103 uses analytics to determine there is a relationship between the car brand and the sports team. For example, the relationship may be that buyers or owners of the car brand are fans of the sports team. In another example, the relationship may be that there is a high correlation between people who view advertisements of the car brand and people who attend events of the sports team. The one or more relationships are outputted.

The active composer module 104 obtains these relationships 402 and obtains social data corresponding to these relationships. The active composer module 104 uses these relationships and corresponding data to compose new social data 403. The active composer module 104 is also configured to automatically create entire messages or derivative messages, or both. The active composer module 104 can subsequently apply analytics to recommend an appropriate, or optimal, message that is machine-created using various social data geared towards a given target audience.

Continuing with the particular example, the active composer module 104 composes a new text article by combining an existing text article about the car brand and an existing text article about the sports team. In another example, the active composer module composes a new article about the car brand by summarizing different existing articles of the car brand, and includes advertisement about the sports team in the new article. In another example, the active composer module identifies people who have generated social data content about both the sports team and the car brand, although the social data for each topic may be published at different times and from different sources, and combines this social content together into a new social data message. In another example embodiment, the active composer module may combine video data and/or audio data related to the car brand with video data and/or audio data related to the sports team to compose new video data and/or audio data. Other combinations of data types can be used.

The active transmitter module 105 obtains the newly composed social data 403 and determines a number of factors or parameters related to the transmission of the newly composed social data. The active transmitter module 105 also inserts or adds markers to track people's responses to the newly composed social data. Based on the transmission factors, the active transmitter module transmits the composed social data with the markers 404. The active transmitter module is also configured to receive feedback regarding the composed social data 405, in which collection of the feedback includes use of the markers. The newly composed social data and any associated feedback 406 are sent to the active receiver module 103.

Continuing with the particular example regarding the car brand and the sports team, the active transmitter module 105 determines trajectory or transmission parameters. For example, social networks, forums, mailing lists, websites, etc. that are known to be read by people who are interested in the car brand and the sports team are identified as transmission targets. Also, special events, such as a competition event, like a game or a match, for the sports team are identified to determine the scheduling or timing for when the composed data should be transmitted. Location of targeted readers will also be used to determine the language of the composed social data and the local time at which the composed social data should be transmitted. Markers, such as number of clicks, number of forwards, time trackers to determine length of time the composed social data is viewed, etc., are used to gather information about people's reaction to the composed social data. The composed social data related to the car brand and the sports team and associated feedback are sent to the active receiver module 103.

Continuing with FIG. 4, the active receiver module 103 receives the composed social data and associated feedback 406. The active receiver module 103 analyses this data to determine if there are any relationships or correlations. For example, the feedback can be used to determine or affirm that the relationship used to generate the newly composed social data is correct, or is incorrect.

Continuing with the particular example regarding the car brand and the sports team, the active receiver module 103 receives the composed social data and the associated feedback. If the feedback shows that people are providing positive comments and positive feedback about the composed social data, then the active receiver module determines that the relationship between the car brand and the sports team is correct. The active receiver module may increase a rating value associated with that particular relationship between the car brand and the sports team. The active receiver module may mine or extract even more social data related to the car brand and the sports team because of the positive feedback. If the feedback is negative, the active receiver module corrects or discards the relationship between the car brand and the sports team. A rating regarding the relationship may decrease. In an example embodiment, the active receiver may reduce or limit searching for social data particular to the car brand and the sports team.

Periodically, or continuously, the social analytic synthesizer module 106 obtains data from the other modules 103, 104, 105. The social analytic synthesizer module 106 analyses the data to determine what adjustments can be made to the operations performed by each module, including module 106. It can be appreciated that by obtaining data from each of modules 103, 104 and 105, the social analytic synthesizer has greater contextual information compared to each of the modules 103, 104, 105 individually.

Continuing with the particular example regarding the car brand and the sports team, the social analytic synthesizer module 106 obtains data that people are responding positively to the newly composed social data object in a second language different than a first language used in the newly composed social data object. Such information can be obtained from the active transmitter module 105 or from the active receiver module 103, or both. Therefore, the social analytic synthesizer module sends an adjustment command to the active composer module 104 to compose new social data about the car brand and the sports team using the second language.

In another example, the social analytic synthesizer module 106 obtains data that positive feedback, about the newly composed social data object regarding the car brand and the sports team, is from a particular geographical vicinity (e.g. a zip code, an area code, a city, a municipality, a state, a province, etc.). This data can be obtained by analyzing data from the active receiver module 103 or from the active transmitter module 105, or both. The social analytic synthesizer then generates and sends an adjustment command to the active receiver module 103 to obtain social data about that particular geographical vicinity. Social data about the particular geographical vicinity includes, for example, recent local events, local jargon and slang, local sayings, local prominent people, and local gathering spots. The social analytic synthesizer generates and sends an adjustment command to the active composer module 104 to compose new social data that combines social data about the car brand, the sports team and the geographical vicinity. The social analytic synthesizer generates and sends an adjustment command to the active transmitter module 105 to send the newly composed social data to people located in the geographical vicinity, and to send the newly composed social data during time periods when people are likely to read or consume such social data (e.g. evenings, weekends, etc.).

Continuing with FIG. 4, each module is also configured to learn from its own gathered data and to improve its own processes and decision making algorithms. Currently known and future known machine learning and machine intelligence computations can be used. For example, the active receiver module 103 has a feedback loop 407; the active composer module 104 has a feedback loop 408; the active transmitter module 105 has a feedback loop 409; and the social analytic synthesizer module has a feedback loop 410. In this way, the process in each module can continuously improve individually, and also improve using the adjustments sent by the social analytic synthesizer module 106. This self-learning on a module-basis and system-wide basis allows the system 102 to be completely automated without human intervention.

It can be appreciated that as more data is provided and as more iterations are performed by the system 102 for sending composed social data, then the system 102 becomes more effective and efficient.

Other example aspects of the system 102 are described below.

The system 102 is configured to capture social data in real time.

The system 102 is configured to analyze social data relevant to a business or, a particular person or party, in real time.

The system 102 is configured to create and compose social data that is targeted to certain people or a certain group, in real time.

The system 102 is configured to determine the best or appropriate times to transmit the newly composed social data.

The system 102 is configured to determine the best or appropriate social channels to reach the selected or targeted people or groups.

The system 102 is configured to determine what people are saying about the new social data sent by the system 102.

The system 102 is configured to apply metric analytics to determine the effectiveness of the social communication process.

The system 102 is configured to determine and recommend analysis techniques and parameters, social data content, transmission channels, target people, and data scraping and mining processes to facilitate continuous loop, end-to-end communication.

The system 102 is configured to add N number of systems or modules, for example, using a master-slave arrangement.

It will be appreciated that the system 102 may perform other operations.

In an example embodiment, computer or processor implemented instructions, which are implemented by the system 102, for providing social communication includes obtaining social data. The system then composes a new social data object derived from the social data. It can be appreciated that the new social data object may have exactly the same content of the obtained social data, or a portion of the content of the obtained social data, or none of the content of the obtained social data. The system transmits the new social data object and obtains feedback associated with the new social data object. The system computes an adjustment command using the feedback, wherein executing the adjustment command adjusts a parameter used in the operations performed by the system.

In an example embodiment, the system obtains a social data object using the active receiver module, and the active composer module passes the social data object to the active transmitter module for transmission. Computation and analysis is performed to determine if the social data object is suitable for transmission, and if so, to which party and at which time should the social data object be transmitted.

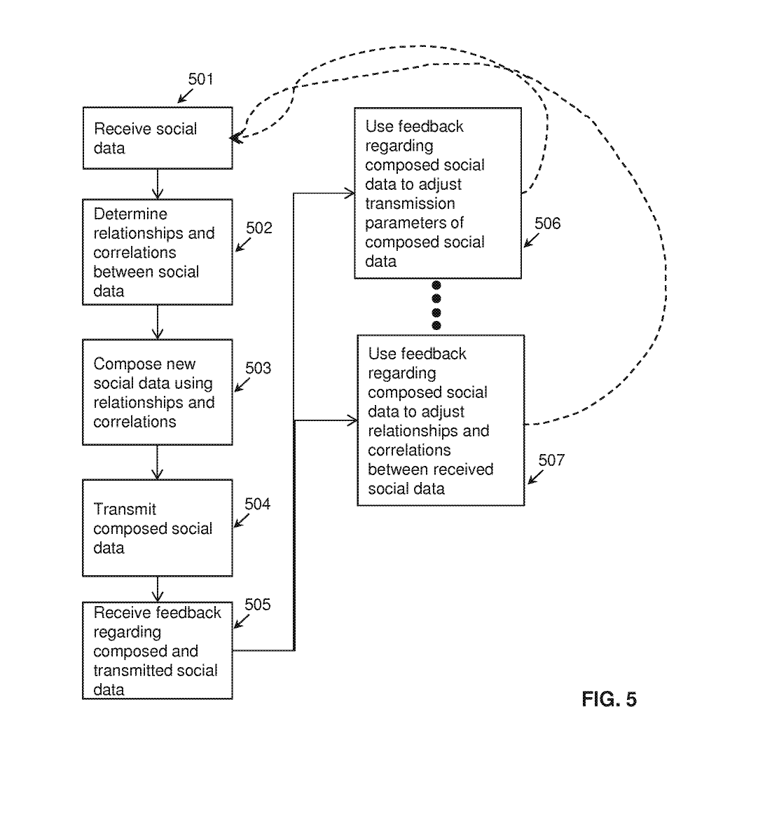

Another example embodiment of computer or processor implemented instructions is shown in FIG. 5 for providing social communication. The instructions are implemented by the system 102. At block 501, the system 102 receives social data. At block 502, the system determines relationships and correlations between social data. At block 503, the system composes new social data using the relationships and the correlations. At block 504, the system transmits the composed social data. At block 505, the system receives feedback regarding the composed social data. At block 506, following block 505, the system uses the feedback regarding the composed social data to adjust transmission parameters of the composed social data. In addition, or in the alternative, at block 507, following block 505, the system uses the feedback regarding the composed social data to adjust relationships and correlations between the received social data. It can be appreciated that other adjustments can be made based on the feedback. As indicated by the dotted lines, the process loops back to block 501 and repeats.

### Active Receiver Module

The active receiver module 103 automatically and dynamically listens to N number of global data streams and is connected to Internet sites or private networks, or both. The active receiver module may include analytic filters to eliminate unwanted information, machine learning to detect valuable information, and recommendation engines to quickly expose important conversations and social trends. Further, the active receiver module is able to integrate with other modules, such as the active composer module 104, the active transmitter module 105, and the social analytic synthesizer module 106.

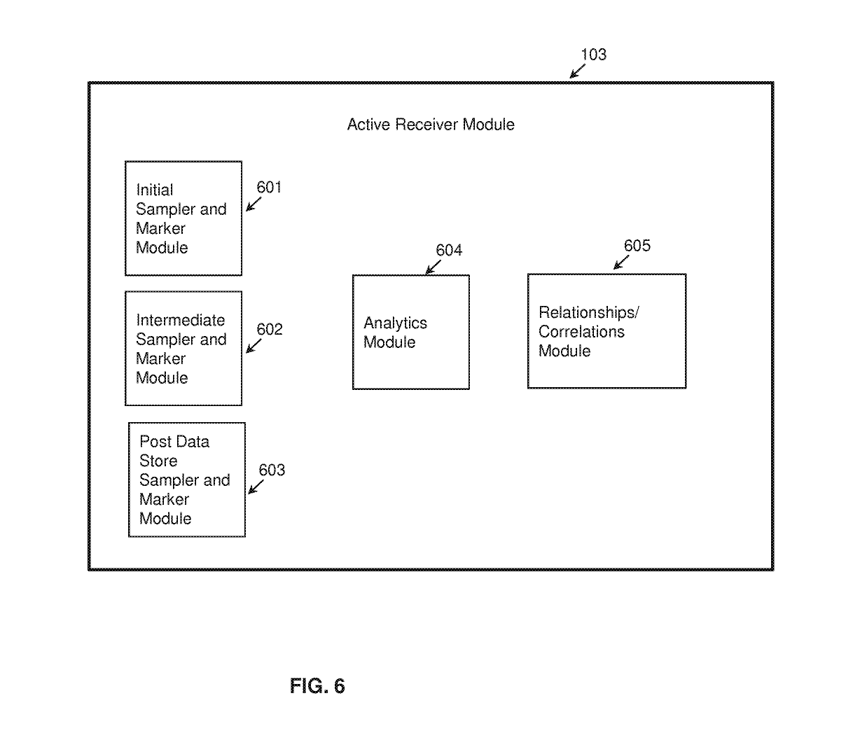

Turning to FIG. 6, example components of the active receiver module 103 are shown. The example components include an initial sampler and marker module 601, an intermediate sampler and marker module 602, a post-data-storage sampler and marker module 603, an analytics module 604, and a relationships/correlations module 605.

To facilitate real-time and efficient analysis of the obtained social data, different levels of speed and granularity are used to process the obtained social data. The module 601 is used first to initially sample and mark the obtained social data at a faster speed and lower sampling rate. This allows the active receiver module 103 to provide some results in real-time. The module 602 is used to sample and mark the obtained data at a slower speed and at a higher sampling rate relative to module 601. This allows the active receiver module 103 to provide more detailed results derived from module 602, although with some delay compared to the results derived from module 601. The module 603 samples all the social data stored by the active receiver module at a relatively slower speed compared to module 602, and with a much higher sampling rate compared to module 602. This allows the active receiver module 103 to provide even more detailed results which are derived from module 603, compared to the results derived from module 602. It can thus be appreciated, that the different levels of analysis can occur in parallel with each other and can provide initial results very quickly, provide intermediate results with some delay, and provide post-data-storage results with further delay.

The sampler and marker modules 601, 602, 603 also identify and extract other data associated with the social data including, for example: the time or date, or both, that the social data was published or posted; hashtags; a tracking pixel; a web bug, also called a web beacon, tracking bug, tag, or page tag; a cookie; a digital signature; a keyword; user and/or company identity associated with the social data; an IP address associated with the social data; geographical data associated with the social data (e.g. geo tags); entry paths of users to the social data; certificates; users (e.g. followers) reading or following the author of the social data; users that have already consumed the social data; etc. This data may be used by the active receiver module 103 and/or the social analytic synthesizer module 106 to determine relationships amongst the social data.

The analytics module 604 can use a variety of approaches to analyze the social data and the associated other data. The analysis is performed to determine relationships, correlations, affinities, and inverse relationships. Non-limiting examples of algorithms that can be used include artificial neural networks, nearest neighbor, Bayesian statistics, decision trees, regression analysis, fuzzy logic, K-means algorithm, clustering, fuzzy clustering, the Monte Carlo method, learning automata, temporal difference learning, apriori algorithms, the ANOVA method, Bayesian networks, and hidden Markov models. More generally, currently known and future known analytical methods can be used to identify relationships, correlations, affinities, and inverse relationships amongst the social data. The analytics module 604, for example, obtains the data from the modules 601, 602, and/or 603.

It will be appreciated that inverse relationships between two concepts, for example, is such that a liking or affinity to first concept is related to a dislike or repelling to a second concept.

The relationships/correlations module 605 uses the results from the analytics module to generate terms and values that characterize a relationship between at least two concepts. The concepts may include any combination of keywords, time, location, people, video data, audio data, graphics, etc.

The relationships module 605 can also identify keyword bursts. The popularity of a keyword, or multiple keywords, is plotted as a function of time. The analytics module identifies and marks interesting temporal regions as bursts in the keyword popularity curve. The analytics module identifies one or more correlated keywords associated with the keyword of interest (e.g. the keyword having a popularity burst). The correlated keyword is closely related to the keyword of interest at the same temporal region as the burst. Such a process is described in detail in U.S. patent application Ser. No. 12/501,324, filed on Jul. 10, 2009 and titled “Method and System for Information Discovery and Text Analysis”, the entire contents of which are incorporated herein by reference.

In another example aspect, the relationships module 605 can also identify relationships between topics (e.g. keywords) and users that are interested in the keyword. The relationships module, for example, can identify a user who is considered an expert in a topic. If a given user regularly comments on a topic, and there many other users who “follow” the given user, then the given user is considered an expert. The relationships module can also identify in which other topics that an expert user has an interest, although the expert user may not be considered an expert of those other topics. The relationships module can obtain a number of ancillary users that a given user follows; obtain the topics in which the ancillary users are considered experts; and associate those topics with the given user. It can be appreciated that there are various ways to correlate topics and users together. Further details are described in U.S. Patent Application No. 61/837,933, filed on Jun. 21, 2013 and titled “System and Method for Analysing Social Network Data”, the entire contents of which are incorporated herein by reference.

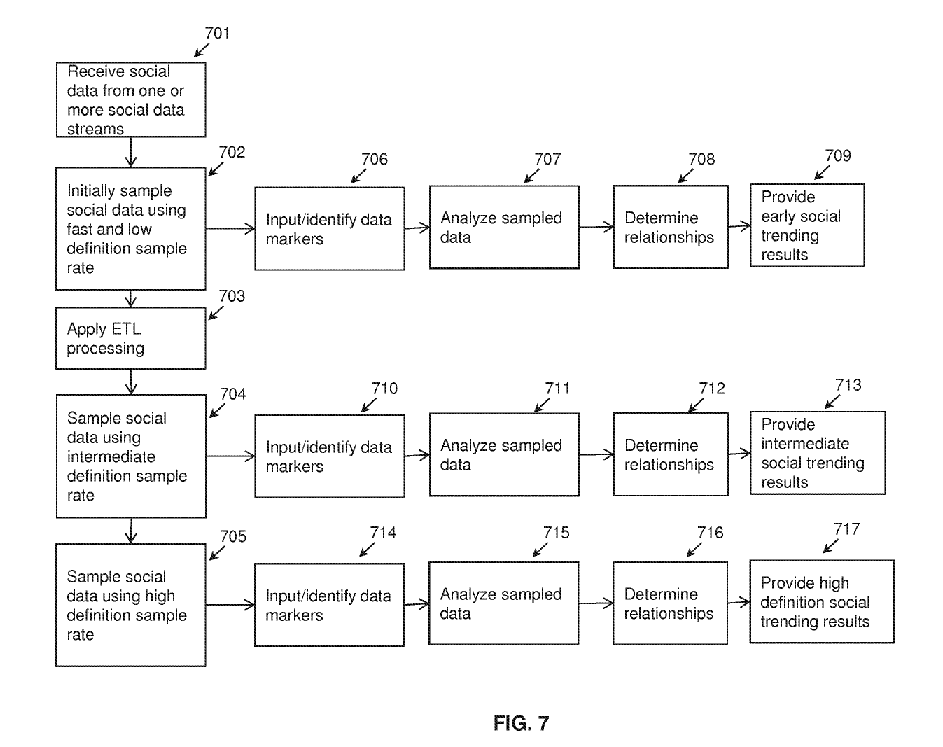

Turning to FIG. 7, example computer or processor implemented instructions are provided for receiving and analysing data according to the active receiver module 103. At block 701, the active receiver module receives social data from one or more social data streams. At block 702, the active receiver module initially samples the social data using a fast and low definition sample rate (e.g. using module 601). At block 703, the active receiver module applies ETL (Extract, Transform, Load) processing. The first part of an ETL process involves extracting the data from the source systems. The transform stage applies a series of rules or functions to the extracted data from the source to derive the data for loading into the end target. The load phase loads the data into the end target, such as the memory.

At block 704, the active receiver module samples the social data using an intermediate definition sample rate (e.g. using 601). At block 705, the active receiver module samples the social data using a high definition sample rate (e.g. using module 603). In an example embodiment, the initial sampling, the intermediate sampling and the high definition sampling are performed in parallel. In another example embodiment, the samplings occur in series.

Continuing with FIG. 7, after initially sampling the social data (block 702), the active receiver module inputs or identifies data markers (block 706). It proceeds to analyze the sampled data (block 707), determine relationships from the sampled data (block 708), and use the relationships to determine early or initial social trending results (block 709).

Similarly, after block 704, the active receiver module inputs or identifies data markers in the sampled social data (block 710). It proceeds to analyze the sampled data (block 711), determine relationships from the sampled data (block 712), and use the relationships to determine intermediate social trending results (block 713).

The active receiver module also inputs or identifies data markers in the sampled social data (block 714) obtained from block 705. It proceeds to analyze the sampled data (block 715), determine relationships from the sampled data (block 716), and use the relationships to determine high definition social trending results (block 717).

In an example embodiment, the operations at block 706 to 709, the operations at block 710 to 713, and the operations at block 714 to 717 occur in parallel. The relationships and results from blocks 708 and 709, however, would be determined before the relationships and results from blocks 712, 713, 716 and 717.

It will be appreciated that the data markers described in blocks 706, 710 and 714 assist with the preliminary analysis and the sampled data and also help to determine relationships. Example embodiments of data markers include keywords, certain images, and certain sources of the data (e.g. author, organization, location, network source, etc.). The data markers may also be tags extracted from the sampled data.

In an example embodiment, the data markers are identified by conducting a preliminary analysis of the sampled data, which is different from the more detailed analysis in blocks 707, 711 and 715. The data markers can be used to identify trends and sentiment.

In another example embodiment, data markers are inputted into the sampled data based on the detection of certain keywords, certain images, and certain sources of data. A certain organization can use this operation to input a data marker into certain sampled data. For example, a car branding organization inputs the data marker “SUV” when an image of an SUV is obtained from the sampling process, or when a text message has at least one of the words “SUV”, “Jeep”, “4×4”, “CR-V”, “Rav4”, and “RDX”. It can be appreciated that other rules for inputting data markers can be used. The inputted data markers can also be used during the analysis operations and the relationship determining operations to detect trends and sentiment.

Other example aspects of the active receiver module are provided below.

The active receiver module 103 is configured to capture, in real time, one or more electronic data streams.

The active receiver module 103 is configured to analyse, in real time, the social data relevant to a business.

The active receiver module 103 is configured to translate text from one language to another language.

The active receiver module 103 is configured to interpret video, text, audio and pictures to create business information. A non-limiting example of business information is sentiment information.

The active receiver module 103 is configured to apply metadata to the received social data in order to provide further business enrichment. Non-limiting examples of metadata include geo data, temporal data, business driven characteristics, analytic driven characteristics, etc.

The active receiver module 103 is configured to interpret and predict potential outcomes and business scenarios using the received social data and the computed information.

The active receiver module 103 is configured to propose user segment or target groups based upon the social data and the metadata received.

The active receiver module 103 is configured to proposed or recommend social data channels that are positively or negatively correlated to a user segment or a target group.

The active receiver module 103 is configured to correlate and attribute groupings, such as users, user segments, and social data channels. In an example embodiment, the active receiver module uses patterns, metadata, characteristics and stereotypes to correlate users, user segments and social data channels.

The active receiver module 103 is configured to operate with little or no human intervention.

The active receiver module 103 is configured to assign affinity data and metadata to the received social data and to any associated computed data. In an example embodiment, affinity data is derived from affinity analysis, which is a data mining technique that discovers co-occurrence relationships among activities performed by (or recorded about) specific individuals, groups, companies, locations, concepts, brands, devices, events, and social networks.

### Active Composer Module

The active composer module 104 is configured to analytically compose and create social data for communication to people. This module may use business rules and apply learned patterns to personalize content. The active composer module is configured, for example, to mimic human communication, idiosyncrasies, slang, and jargon. This module is configured to evaluate multiple social data pieces or objects composed by itself (i.e. module 104), and further configured to evaluate ranks and recommend an optimal or an appropriate response based on the analytics. Further, the active composer module is able to integrate with other modules, such as the active receiver module 103, the active transmitter module 105, and the social analytic synthesizer module 106. The active composer module can machine-create multiple versions of a personalized content message and recommend an appropriate, or optimal, solution for a target audience.

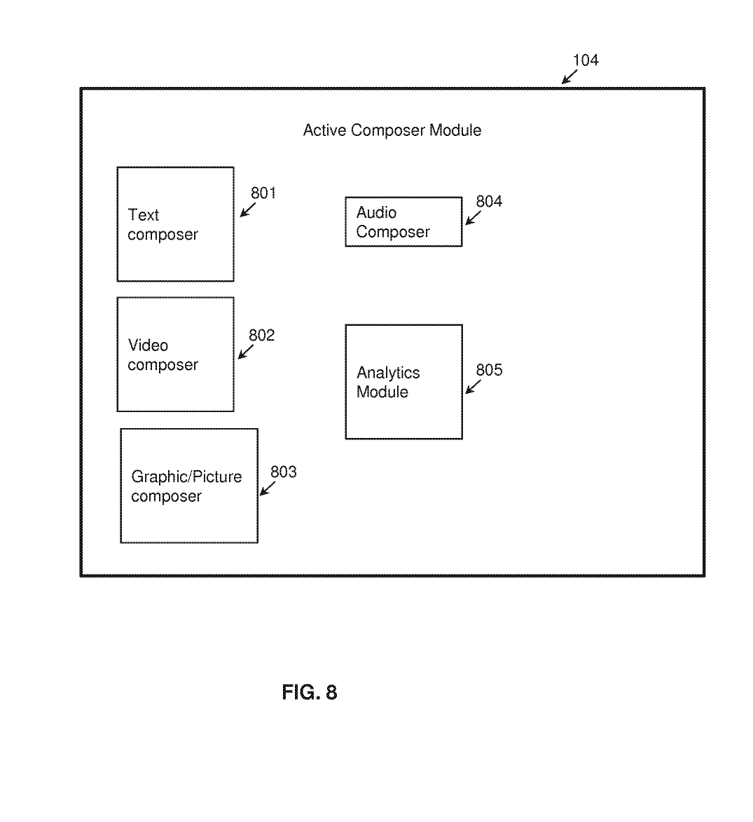

Turning to FIG. 8, example components of the active composer module 104 are shown. Example components include a text composer module 801, a video composer module 802, a graphics/picture composer module 803, an audio composer 804, and an analytics module 805. The composer modules 801, 802, 803 and 804 can operate individually to compose new social data within their respective media types, or can operate together to compose new social data with mixed media types.

The analytics module 805 is used to analyse the outputted social data, identify adjustments to the composing process, and generate commands to make adjustments to the composing process.

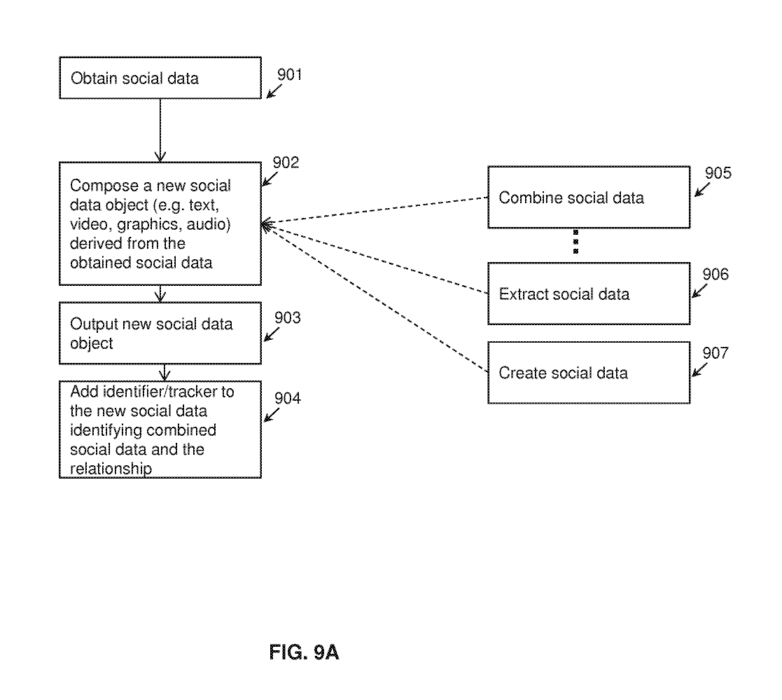

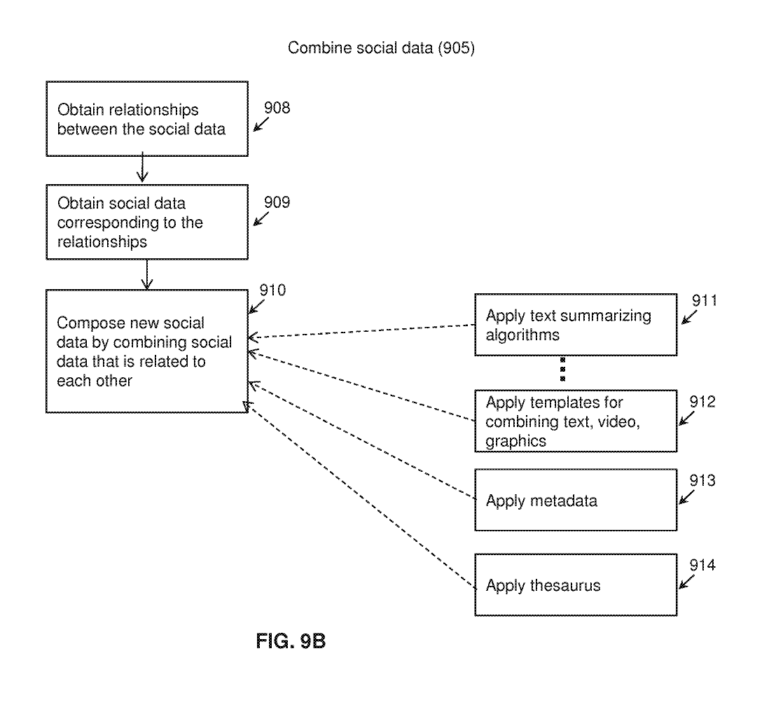

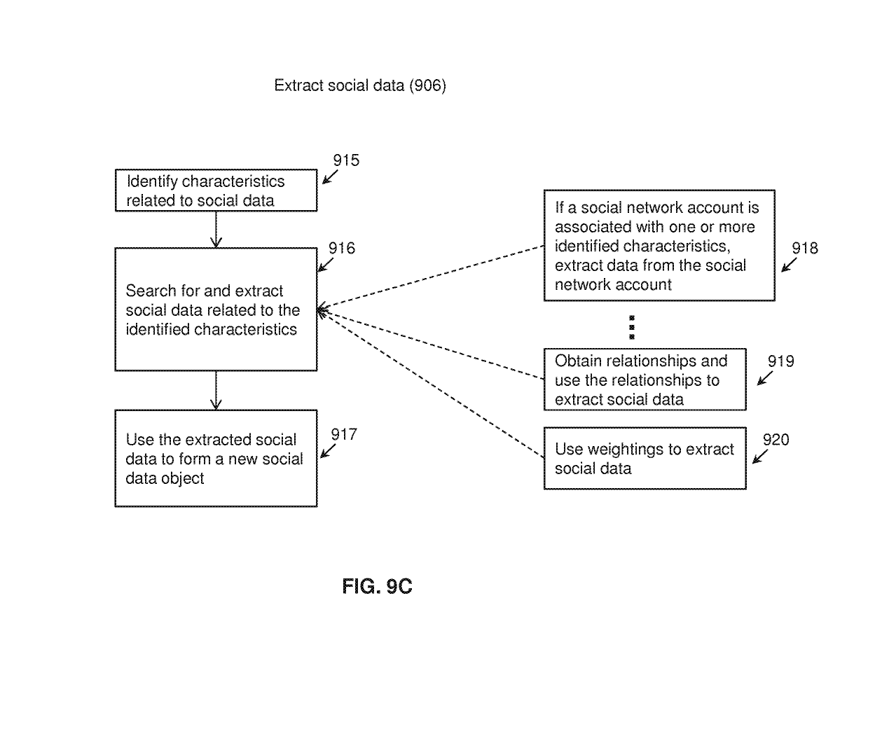

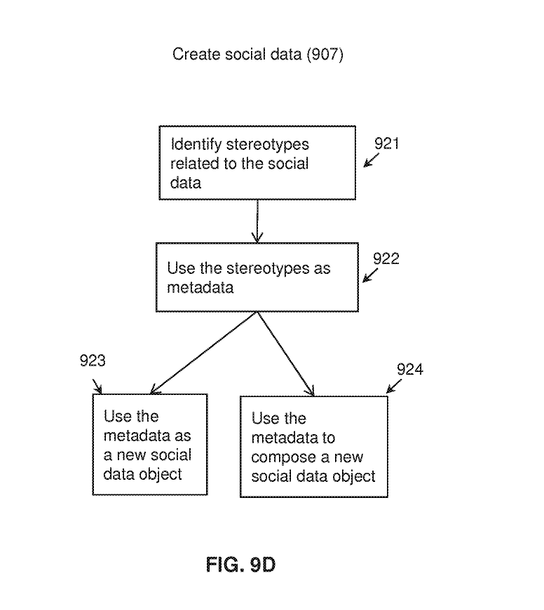

Turning to FIG. 9A, example computer or processor implemented instructions are provided for composing social data according the module 104. The active composer module obtains social data, for example from the active receiver module 103 (block 901). The active composer module then composes a new social data object (e.g. text, video, graphics, audio) derived from the obtained social data (block 902).

Various approaches can be used to compose the new social data object, or new social data objects. For example, social data can be combined to create the new social data object (block 905), social data can be extracted to create the new social object (block 906), and new social data can be created to form the new social data object (block 907). The operations from one or more of blocks 905, 906 and 907 can be applied to block 902. Further details in this regard are described in FIGS. 9B, 9C and 9D.

Continuing with FIG. 9A, at block 903, the active composer module outputs the composed social data. The active composer module may also add identifiers or trackers to the composed social data, which are used to identify the sources of the combined social data and the relationship between the combined social data.

Turning to FIG. 9B, example computer or processor implemented instructions are provided for combining social data according to block 905. The active composer module obtains relationships and correlations between the social data (block 908). The relationships and correlations, for example, are obtained from the active receiver module. The active composer module also obtains the social data corresponding to the relationships (block 909). The social data obtained in block 909 may be a subset of the social data obtained by the active receiver module, or may be obtained by third party sources, or both. At block 910, the active composer module composes new social data (e.g. a new social data object) by combining social data that is related to each other.

It can be appreciated that various composition processes can be used when implementing block 910. For example, a text summarizing algorithm can be used (block 911). In another example, templates for combining text, video, graphics, etc. can be used (block 912). In an example embodiment, the templates may use natural language processing to generate articles or essays. The template may include a first section regarding a position, a second section including a first argument supporting the position, a third section including a second argument supporting the position, a fourth section including a third argument supporting the position, and a fifth section including a summary of the position. Other templates can be used for various types of text, including news articles, stories, press releases, etc.

Natural language processing catered to different languages can also be used. Natural language generation can also be used. It can be appreciated that currently know and future known composition algorithms that are applicable to the principles described herein can be used.

Natural language generation includes content determination, document structuring, aggregation, lexical choice, referring expression generation, and realisation. Content determination includes deciding what information to mention in the text. In this case the information is extracted from the social data associated with an identified relationship. Document structuring is the overall organisation of the information to convey. Aggregation is the merging of similar sentences to improve readability and naturalness. Lexical choice is putting words to the concepts. Referring expression generation includes creating referring expressions that identify objects and regions. This task also includes making decisions about pronouns and other types of anaphora. Realisation includes creating the actual text, which should be correct according to the rules of syntax, morphology, and orthography. For example, using “will be” for the future tense of “to be”.

Continuing with FIG. 9B, metadata obtained from the active receiver module, or obtained from third party sources, or metadata that has been generated by the system 102, may also be applied when composing the new social data object (block 913). Furthermore, a thesaurus database, containing words and phrases that are synonymous or analogous to keywords and key phrases, can also be used to compose the new social data object (block 914). The thesaurus database may include slang and jargon.

Turning to FIG. 9C, example computer or processor implemented instructions are provided for extracting social data according to block 906. At block 915, the active composer module identifies characteristics related to the social data. These characteristics can be identified using metadata, tags, keywords, the source of the social data, etc. At block 916, the active composer module searches for and extracts social data that is related to the identified characteristics.

For example, one of the identified characteristics is a social network account name of a person, an organization, or a place. The active composer module will then access the social network account to extract data from the social network account. For example, extracted data includes associated users, interests, favourite places, favourite foods, dislikes, attitudes, cultural preferences, etc. In an example embodiment, the social network account is a LinkedIn account or a Facebook account. This operation (block 918) is an example embodiment of implementing block 916.

Another example embodiment of implementing block 916 is to obtain relationships and use the relationships to extract social data. Relationships can be obtained in a number of ways, including but not limited to the methods described herein. Another example method to obtain a relationship is using Pearson's correlation. Pearson's correlation is a measure of the linear correlation (dependence) between two variables X and Y, giving a value between +1 and −1 inclusive, where 1 is total positive correlation, 0 is no correlation, and −1 is negative correlation. For example, if given data X, and it is determined X and data Y are positively correlated, then data Y is extracted.

Another example embodiment of implementing block 916 is to use weighting to extract social data (block 920). For example, certain keywords can be statically or dynamically weighted based on statistical analysis, voting, or other criteria. Characteristics that are more heavily weighted can be used to extract social data. In an example embodiment, the more heavily weighted a characteristic is, the wider and the deeper the search will be to extract social data related to the characteristic.

Other approaches for searching for and extracting social data can be used.

At block 917, the extracted social data is used to form a new social data object.

Turning to FIG. 9D, example computer or processor implemented instructions are provided for creating social data according to block 907. At block 921, the active composer module identifies stereotypes related to the social data. Stereotypes can be derived from the social data. For example, using clustering and decision tree classifiers, stereotypes can be computed.

In an example stereotype computation, a model is created. The model represents a person, a place, an object, a company, an organization, or, more generally, a concept. As the system 102, including the composer module, gains experience obtaining data and feedback regarding the social communications being transmitted, the active composer module is able to modify the model. Features or stereotypes are assigned to the model based on clustering. In particular, clusters representing various features related to the model are processed using iterations of agglomerative clustering. If certain of the clusters meet a predetermined distance threshold, where the distance represents similarity, then the clusters are merged. For example, the Jaccard distance (based on the Jaccard index), a measure used for determining the similarity of sets, is used to determine the distance between two clusters. The cluster centroids that remain are considered as the stereotypes associated with the model. For example, the model may be a clothing brand that has the following stereotypes: athletic, running, sports, swoosh, and ‘just do it’.

In another example stereotype computation, affinity propagation is used to identify common features, thereby identifying a stereotype. Affinity propagation is a clustering algorithm that, given a set of similarities between pairs of data points, exchanges messages between data points so as to find a subset of exemplar points that best describe the data. Affinity propagation associates each data point with one exemplar, resulting in a partitioning of the whole data set into clusters. The goal of affinity propagation is to minimize the overall sum of similarities between data points and their exemplars. Variations of the affinity propagation computation can also be used. For example, a binary variable model of affinity propagation computation can be used. A non-limiting example of a binary variable model of affinity propagation is described in the document by Inmar E. Givoni and Brendan J. Frey, titled “A Binary Variable Model of Affinity Propagation”, Neural Computation 21, 1589-1600 (2009), the entire contents of which are hereby incorporated by reference.

Another example stereotype computation is Market Basket Analysis (Association Analysis), which is an example of affinity analysis. Market Basket Analysis is a mathematical modeling technique based upon the theory that if you buy a certain group of products, you are likely to buy another group of products. It is typically used to analyze customer purchasing behavior and helps in increasing the sales and maintain inventory by focusing on the point of sale transaction data. Given a dataset, an apriori algorithm trains and identifies product baskets and product association rules. However, the same approach is used herein to identify characteristics of a person (e.g. stereotypes) instead of products. Furthermore, in this case, users' consumption of social data (e.g. what they read, watch, listen to, comment on, etc.) is analyzed. The apriori algorithm trains and identifies characteristic (e.g. stereotype) baskets and characteristic association rules.

Other methods for determining stereotypes can be used.

Continuing with FIG. 9D, the stereotypes are used as metadata (block 922). In an example embodiment, the metadata is the new social data object (block 923), or the metadata can be used to derive or compose a new social data object (block 924).

It can be appreciated that the methods described with respect to blocks 905, 906 and 907 to compose a new social data object can be combined in various way, though not specifically described herein. Other ways of composing a new social data object can also be applied.

In an example embodiment of composing a social data object, the social data includes the name “Chris Farley”. To compose a new social data object, social data is created using stereotypes. For example, the stereotypes ‘comedian’, ‘fat’, ‘ninja’, and ‘blonde’ are created and associated with Chris Farley. The stereotypes are then used to automatically create a caricature (e.g. a cartoon-like image of Chris Farley). The image of the person is automatically modified to include a funny smile and raised eye brows to correspond with the ‘comedian’ stereotype. The image of the person is automatically modified to have a wide waist to correspond with the ‘fat’ stereotype. The image of the person is automatically modified to include ninja clothing and weaponry (e.g. a sword, a staff, etc.) to correspond with the ‘ninja’ stereotype. The image of the person is automatically modified to include blonde hair to correspond with the ‘blonde’ stereotype. In this way, a new social data object comprising the caricature image of Chris Farley is automatically created. Various graphic generation methods, derived from text, can be used. For example, a mapping database contains words that are mapped to graphical attributes, and those graphical attributes in turn can be applied to a template image. Such a mapping database could be used to generate the caricature image.

In another example embodiment, the stereotypes are used to create a text description of Chris Farley, and to identify in the text description other people that match the same stereotypes. The text description is the composed social data object. For example, the stereotypes of Chris Farely could also be used to identify the actor “John Belushi” who also fits the stereotypes of ‘comedian’ and ‘ninja’. Although the above examples pertain to a person, the same principles of using stereotypes to compose social data also apply to places, cultures, fashion trends, brands, companies, objects, etc.

The active composer module 104 is configured to operate with little or no human intervention.

### Active Transmitter Module

The active transmitter module 105 analytically assesses preferred or appropriate social data channels to communicate the newly composed social data to certain users and target groups. The active transmitter module also assesses the preferred time to send or transmit the newly composed social data.

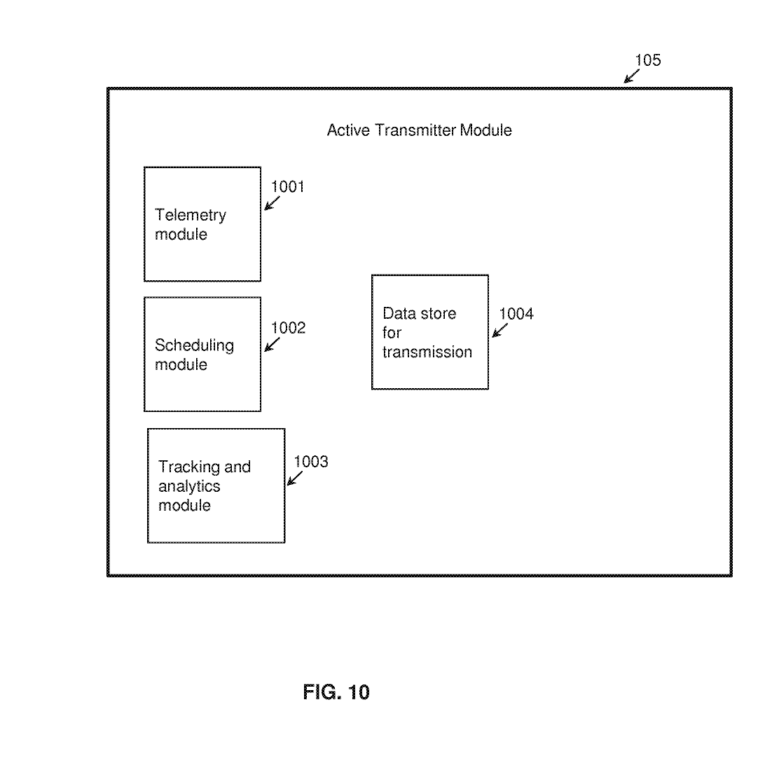

Turning to FIG. 10, example components of the active transmitter module 105 are shown. Example components include a telemetry module 1001, a scheduling module 1002, a tracking and analytics module 1003, and a data store for transmission 1004. The telemetry module 1001 is configured to determine or identify over which social data channels a certain social data object should be sent or broadcasted. A social data object may be a text article, a message, a video, a comment, an audio track, a graphic, or a mixed-media social piece. For example, a social data object about a certain car brand should be sent to websites, RSS feeds, video or audio channels, blogs, or groups that are viewed or followed by potential car buyers, current owners of the car brand and past owners of the car brand. The scheduling module 1002 determines a preferred time range or date range, or both, for sending a composed social data object. For example, if a newly composed social data object is about stocks or business news, the composed social data object will be scheduled to be sent during working hours of a work day. The tracking and analytics module 1003 inserts data trackers or markers into a composed social data object to facilitate collection of feedback from people. Data trackers or markers include, for example, tags, feedback (e.g. like, dislike, ratings, thumb up, thumb down, etc.), number of views on a web page, etc.

The data store for transmission 1004 stores a social data object that has the associated data tracker or marker. The social data object may be packaged as a “cart”. Multiple carts, having the same social data object or different social data objects, are stored in the data store 1004. The carts are launched or transmitted according to associated telemetry and scheduling parameters. The same cart can be launched multiple times. One or more carts may be organized under a campaign to broadcast composed social data. The data trackers or markers are used to analyse the success of a campaign, or of each cart.

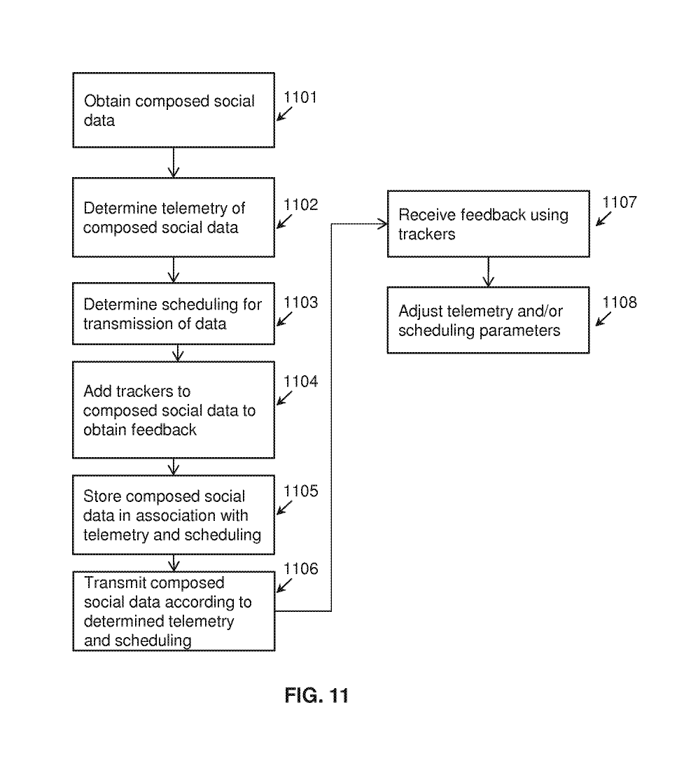

Turning to FIG. 11, example computer or processor implemented instructions are provided for transmitting composed social data according the active transmitter module 105. At block 1101, the active transmitter module obtains the composed social data. At block 1102, the active transmitter module determines the telemetry of the composed social data. At block 1103, the active transmitter module determines the scheduling for the transmission of the composed social data. Trackers, which are used to obtain feedback, are added to the composed social data (block 1104), and the social data including the trackers are stored in association with the scheduling and telemetry parameters (block 1105). At the time determined by the scheduling parameters, the active transmitter module sends the composed social data to the identified social data channels, as per the telemetry parameters (block 1106).

Continuing with FIG. 11, the active transmitter module receives feedback using the trackers (block 1107) and uses the feedback to adjust telemetry or scheduling parameters, or both (block 1108).

Other example aspects of the active transmitter module 105 are provided below.

The active transmitter module 105 is configured to transmits messages and, generally, social data with little or no human intervention

The active transmitter module 105 is configured to uses machine learning and analytic algorithms to select one or more data communication channels to communicate a composed social data object to an audience or user(s). The data communication channels include, but are not limited to, Internet companies such as FaceBook, Twitter, and Bloomberg. Channel may also include traditional TV, radio, and newspaper publication channels.

The active transmitter module 105 is configured to automatically broaden or narrow the target communication channel(s) to reach a certain target audience or user(s).

The active transmitter module 105 is configured to integrate data and metadata from third party companies or organizations to help enhance channel targeting and user targeting, thereby improving the effectiveness of the social data transmission.

The active transmitter module 105 is configured to apply and transmit unique markers to track composed social data. The markers track the effectiveness of the composed social data, the data communication channel's effectiveness, and ROI (return on investment) effectiveness, among other key performance indicators.

The active transmitter module 105 is configured to automatically recommend the best time or an appropriate time to send/transmit the composed social data.

The active transmitter module 105 is configured to listen and interpret whether the composed social data was successfully received by the data communication channel(s), or viewed/consumer by the user(s), or both.

The active transmitter module 105 is configured to analyse the user response of the composed social data and automatically make changes to the target channel(s) or user(s), or both. In an example, the decision to make changes is based on successful or unsuccessful transmission (receipt by user).

The active transmitter module 105 is configured to filter out certain data communication channel(s) and user(s) for future or subsequent composed social data transmissions.

The active transmitter module 105 is configured to repeat the transmission of previously sent composed social data for N number of times depending upon analytic responses received by the active transmitter module. The value of N in this scenario may be analytically determined.

The active transmitter module 105 is configured to analytically determine a duration of time between each transmission campaign.

The active transmitter module 105 is configured to apply metadata from the active composer module 104 to the transmission of the composed social data, in order to provide further business information enrichment. The metadata includes, but is not limited to, geo data, temporal data, business driven characteristics, unique campaign IDs, keywords, hash tags or equivalents, analytic driven characteristics, etc.

The active transmitter module 105 is configured to scale in size, for example, by using multiple active transmitter modules 105. In other words, although one module 105 is shown in the figures, there may be multiple instances of the same module to accommodate large scale transmission of data.

### Social Analytic Synthesizer Module

The social analytic synthesizer module 106 is configured to perform machine learning, analytics, and to make decisions according to business driven rules. The results and recommendations determined by the social analytic synthesizer module 106 are intelligently integrated with any one or more of the active receiver module 103, the active composer module 104, and the active transmitter module 105, or any other module that can be integrated with the system 102. This module 106 may be placed or located in a number of geo locations, facilitating real time communication amongst the other modules. This arrangement or other arrangements can be used for providing low latency listening, social content creation and content transmission on a big data scale.

The social analytic synthesizer module 106 is also configured to identify unique holistic patterns, correlations, and insights. In an example embodiment, the module 106 is able to identify patterns or insights by analysing all the data from at least two other modules (e.g. any two or more of modules 103, 104 and 105), and these patterns or insights would not have otherwise been determined by individually analysing the data from each of the modules 104, 104 and 105. The feedback or an adjustment command is provided by the social analytic synthesizer module 106, in an example embodiment, in real time to the other modules. Over time and over a number of iterations, each of the modules 103, 104, 105 and 106 become more effective and efficient at continuous social communication and at their own respective operations.

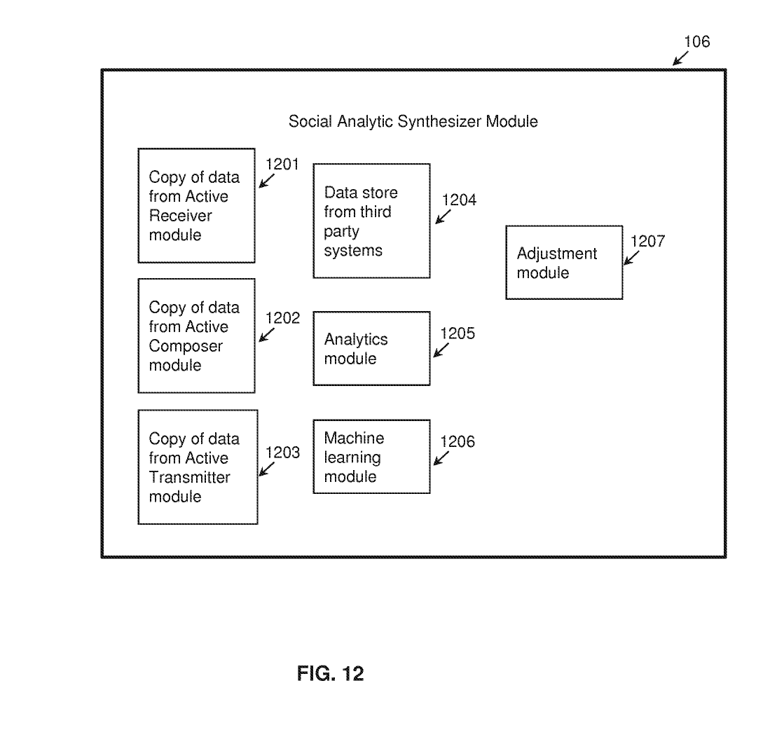

Turning to FIG. 12, example components of the social analytic synthesizer module 106 are shown. Example components include a copy of data from the active receiver module 1201, a copy of data from the active composer module 1202, and a copy of data from the active transmitter module 1203. These copies of data include the inputted data obtained by each module, the intermediary data, the outputted data of each module, the algorithms and computations used by each module, the parameters used by each module, etc. Preferably, although not necessarily, these data stores 1201, 1202 and 1203 are updated frequently. In an example embodiment, the data from the other modules 103, 104, 105 are obtained by the social analytic synthesizer module 106 in real time as new data from these other modules become available.

Continuing with FIG. 12, example components also include a data store from a third party system 1204, an analytics module 1205, a machine learning module 1206 and an adjustment module 1207. The analytics module 1205 and the machine learning module 1206 process the data 1201, 1202, 1203, 1204 using currently known and future known computing algorithms to make decisions and improve processes amongst all modules (103, 104, 105, and 106). The adjustment module 1207 generates adjustment commands based on the results from the analytics module and the machine learning module. The adjustment commands are then sent to the respective modules (e.g. any one or more of modules 103, 104, 105, and 106).

In an example embodiment, data from a third party system 1204 can be from another social network, such as LinkedIn, Facebook, Twittter, etc.

Other example aspects of the social analytic synthesizer module 106 are below.

The social analytic synthesizer module 106 is configured to integrate data in real time from one or more sub systems and modules, included but not limited to the active receiver module 103, the active composer module 104, and the active transmitter module 105. External or third party systems can be integrated with the module 106.

The social analytic synthesizer module 106 is configured to apply machine learning and analytics to the obtained data to search for “holistic” data patterns, correlations and insights.

The social analytic synthesizer module 106 is configured to feed back, in real time, patterns, correlations and insights that were determined by the analytics and machine learning processes. The feedback is directed to the modules 103, 104, 105, and 106 and this integrated feedback loop improves the intelligence of each module and the overall system 102 over time.

The social analytic synthesizer module 106 is configured to scale the number of such modules. In other words, although the figures show one module 106, there may be multiple instances of such a module 106 to improve the effectiveness and response time of the feedback.

The social analytic synthesizer module 106 is configured to operate with little or no human intervention.

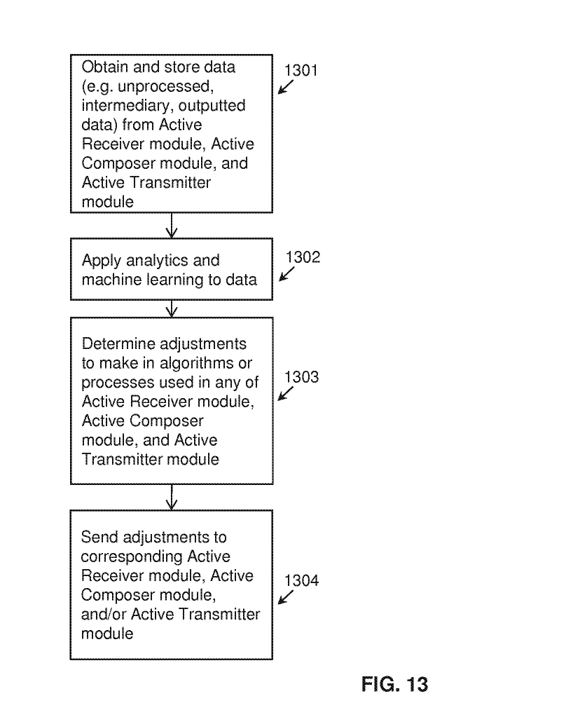

Turning to FIG. 13, example computer or processor implemented instructions are provided for analysing data and providing adjustment commands based on the analysis, according to module 106. At block 1301, the social analytic synthesizer module obtains and stores data from the active receiver module, the active composer module and the active transmitter module. Analytics and machine learning are applied to the data (block 1302). The social analytic synthesizer determines adjustments to make in the algorithms or processes used in any of the active receiver module, active composer module, and the active transmitter module (block 1303). The adjustments, or adjustment commands, are then sent to the corresponding module or corresponding modules (block 1304).

General example embodiments of the systems and methods are described below.

In general, a method performed by a computing device for communicating social data, includes: obtaining social data; deriving at least two concepts from the social data; determining a relationship between the at least two concepts; composing a new social data object using the relationship; transmitting the new social data object; obtaining user feedback associated with new social data object; and computing an adjustment command using the user feedback, wherein executing the adjustment command adjusts a parameter used in the method.

In an aspect of the method, an active receiver module is configured to at least obtain the social data, derive the least two concepts from the social data, and determine the relationship between the at least two concepts; an active composer module is configured to at least compose the new social data object using the relationship; an active transmitter module is configured to at least transmit the new social data object; and wherein the active receiver module, the active composer module and the active transmitter module are in communication with each other.

In an aspect of the method, each of the active receiver module, the active composer module and the active transmitter module are in communication with a social analytic synthesizer module, and the method further includes the social analytic synthesizer module sending the adjustment command to at least one of the active receiver module, the active composer module and the active transmitter module.

In an aspect of the method, the method further includes executing the adjustment command and repeating the method.

In an aspect of the method, obtaining the social data includes the computing device communicating with multiple social data streams in real time.

In an aspect of the method, determining the relationship includes using a machine learning algorithm or a pattern recognition algorithm, or both.

In an aspect of the method, composing the new social data object includes using natural language generation.

In an aspect of the method, the method further includes determining a social communication channel over which to transmit the new social data object, and transmitting the new social data object over the social communication channel, wherein the social communication channel is determined using at least one of the at least two concepts.

In an aspect of the method, the method further includes determining a time at which to transmit the new social data object, and transmitting the new social data object at the time, wherein the time is determined using at least one of the at least two concepts.

In an aspect of the method, the method further includes adding a data tracker to the new social data object before transmitting the new social data object, wherein the data tracker facilitates collection of the user feedback.

In an aspect of the method, the new social data object is any one of text, a video, a graphic, audio data, or a combination thereof.

It will be appreciated that different features of the example embodiments of the system and methods, as described herein, may be combined with each other in different ways. In other words, different modules, operations and components may be used together according to other example embodiments, although not specifically stated.

The steps or operations in the flow diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific embodiments, various modifications thereof will be apparent to those skilled in the art without departing from the scope of the claims appended hereto.

1. A method performed by a computing device for communicating social data, comprising:
obtaining social data;
composing a new social data object derived from the social data;
transmitting the new social data object;
obtaining user feedback associated with new social data object; and
computing an adjustment command using the user feedback, wherein executing the adjustment command adjusts a parameter used in the method.

2. The method of claim 1 further comprising: deriving at least two concepts from the social data; determining a relationship between the at least two concepts; and composing the new social data object using the relationship.

3. The method of claim 1 wherein the social data comprises a social data object and the new social data object comprises the social data object.

4. The method of claim 1 wherein an active receiver module is configured to at least obtain the social data; an active composer module is configured to at least compose the new social data object; an active transmitter module is configured to at least transmit the new social data object; and wherein the active receiver module, the active composer module and the active transmitter module are in communication with each other.

5. The method of claim 4 wherein each of the active receiver module, the active composer module and the active transmitter module are in communication with a social analytic synthesizer module, and the method further comprising the social analytic synthesizer module sending the adjustment command to at least one of the active receiver module, the active composer module and the active transmitter module.

6. The method of claim 1 further comprising executing the adjustment command and repeating the method.

7. The method of claim 1 wherein obtaining the social data comprises the computing device communicating with multiple social data streams in real time.

8. The method of claim 2 wherein determining the relationship comprises using a machine learning algorithm or a pattern recognition algorithm.

9. The method of claim 1 wherein composing the new social data object comprises using natural language generation.

10. The method of claim 1 further comprising determining a social communication channel over which to transmit the new social data object, and transmitting the new social data object over the social communication channel, wherein the social communication channel is determined using at least one of the at least two concepts.

11. The method of claim 1 further comprising determining a time at which to transmit the new social data object, and transmitting the new social data object at the time, wherein the time is determined using at least one of the at least two concepts.

12. The method of claim 1 further comprising adding a data tracker to the new social data object before transmitting the new social data object, wherein the data tracker facilitates collection of the user feedback.

13. The method of claim 1 wherein the new social data object is any one of text, a video, a graphic, audio data, or a combination thereof.

14. A server system configured to communicate social data, comprising:
a processor;
a communication device;
a memory device; and
wherein the memory device comprises computer executable instructions for at least:
obtain social data;
compose a new social data object derived from the social data;
transmit the new social data object;
obtain user feedback associated with new social data object; and
compute an adjustment command using the user feedback, wherein executing the adjustment command adjusts a parameter used in the computer executable instructions.
